(19) United States
(12) Patent Application Publication
(10) Pub. No.: US 2004/0055899 A1
(43) Pub. Date: Mar. 25, 2004

(54) Method for improving a chemo/electro-active material

(76) Inventors: Patricia A. Morris, Monthcanin, DE (US); John Carl Steichen, Landenberg, PA (US); J.J. Barnes, Hockessin, DE (US); Charles E. Miller, Spring, TX (US); Eugene Michael McCarron III, Greenville, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/413,815

(22) Filed: Apr. 15, 2003

Related U.S. Application Data
(60) Provisional application No. 60/372,875, filed on Apr. 15, 2002.

(51) Int. Cl. G01N 27/26

(52) U.S. Cl. 205/781; 204/431

(57) ABSTRACT

Disclosed herein is a method of improving a chemo/electro-active material by increasing the sensitivity of the material; increasing the stability of an electrical response characteristic of the chemo/electro-active material; or increasing the speed with which a change in an electrical response characteristic of the chemo/electro-active material is detected.

This application claims the benefit of U.S. Provisional Application No. 60/372,875, filed Apr. 15, 2002, which is incorporated in its entirety as a part hereof for all purposes.

### FIELD OF THE INVENTION

The present invention involves an apparatus for sensing and analyzing various gases, including NO_{X}, hydrocarbons, carbon monoxide and oxygen, in a multi-component gas system using chemical sensors and chemical sensor arrays. The sensors and sensor arrays use chemo/electro-active materials to detect the presence of, and/or calculate the concentration of, individual gases within the multi-component gas system.

### BACKGROUND OF THE INVENTION

The use of chemical sensing devices to detect certain gases is known. Many attempts have been made to find a material with selectivity and sensitivity for a specific gas. For example, U.S. Pat. No. 4,535,316 discloses a resistive sensor for measuring oxygen. See also H. Meixner et al, Sensors and Actuators, B 33 (1996) 198-202. It is apparent that different materials must be used for each gas to be detected. However, when a gas is part of a multi-component system, using one material to detect a specific gas is difficult because of the cross-sensitivities of the material to the various component gases of the mixture.

One example of a multi-component gaseous system is a combustion gas emission, which can include oxygen, carbon monoxide, nitrogen oxides, hydrocarbons, CO₂, H₂S, sulfur dioxide, hydrogen, water vapor, halogens and ammonia. See H. Meixner et al, Fresenius' J. Anal. Chem., 348 (1994) 536-541. In many combustion processes, there is a need to determine whether the gas emissions meet requirements established by federal and state air quality regulations. Several types of gas sensors have been developed to address this need. See, for example, U.S Pat. No. 5,630,920, which discloses an electrochemical oxygen sensor; U.S. Pat. No. 4,770,760, which discloses a sensor for detecting oxygen and oxides of nitrogen; and U.S. Pat. No. 4,535,316, which discloses a resistive sensor for measuring oxygen. It would be advantageous to be able to simultaneously analyze two or more components of a mixture such as a combustion gas emission, to calculate concentration for example, in terms only of data generated by direct contact of the gases with a sensor and without having to separate any of the gases in the mixture. Prior art methods do not currently meet this need.

Numerous sensors have also been disclosed to detect gases evolving from foods and for use in other applications involving relatively low temperatures. See K. Albert et al, Chem. Rev., 200 (2000) 2595-2626. Arrays of several undoped and doped tin oxide sensors have also been disclosed for use in detecting various combustion gases up to 450° C. [see C. Di Natale et al, Sensors and Actuators, B 20 (1994) 217-224; and J. Getino et al, Sensors and Actuators, B33 (1996) 128-133]; and the effect of operating temperature on the response of tin oxide bases sensor arrays was studied up to 450° C. See C. Di Natale, Sensors and Actuators B23 (1995) 187-191. Higher temperatures, however, and the highly corrosive environment in which chemical sensors would be used to monitor combustion gases, can alter or impair the performance of a sensor array developed for low-temperature applications. High temperature environments consequently require materials other than those previously known in the art that will be both chemically and thermally stable, and that will maintain measurable responses to the gases of interest, in such demanding conditions.

Addressing this need would permit the use of a chemical sensor to measure combustion emissions, such as automobile exhausts, and determine whether those emissions meet functional and mandated requirements. In addition, it has surprisingly been found that the apparatus of this invention that are useful for analyzing high temperature gases, such as automotive emissions, may be employed with equal effectiveness in analyzing low temperature gases.

### SUMMARY OF THE INVENTION

One embodiment of this invention is, in a chemo/electro-active material that exhibits an electrical response characteristic to a multi-component gas mixture, a method of increasing the sensitivity of the chemo/electro-active material that has a first sensitivity at a first temperature, by raising the temperature of the chemo/electro-active material to a second temperature at which the sensitivity of the chemo/electro-active material is increased to a second sensitivity that is greater than the first sensitivity; wherein the sensitivity of the chemo/electro-active material is the ratio given by ΔR/ΔC, where AR is the change in resistance, or in the size of a signal proportional to resistance, experienced by the chemo/electro-active material at a selected temperature as a result of a change in concentration of a component gas or subgroup of gases in the multi-component gas mixture, and ΔC is the change in concentration of the component gas or subgroup of gases.

Another embodiment of this invention is, in a chemo/electro-active material that exhibits an electrical response characteristic to a multi-component gas mixture, a method of increasing the stability of the electrical response characteristic of the chemo/electro-active material that has a first stability at a first temperature, by raising the temperature of the chemo/electro-active material to a second temperature at which the stability of the chemo/electro-active material is increased to a second stability that is greater than the first stability; wherein the stability of the electrical response characteristic of the chemo/electro active material is the ratio given by ΔE/T, where ΔE is the change in the quantified value of the electrical response characteristic, or in the size of a signal proportional to the electrical response characteristic, that occurs as a result of exposure to the multi-component gas mixture over a selected period of time, and T is the selected period of time.

A further embodiment of this invention is, in a chemo/electro-active material that exhibits an electrical response characteristic to a multi-component gas mixture, a method of increasing the speed with which a change in an electrical response characteristic is detected where the change in the electrical response characteristic is detected at a first speed at a first temperature, by raising the temperature of the chemo/electro-active material to a second temperature at which the speed with which the electrical response characteristic of the chemo/electro-active material is detected is increased to a second speed that is greater than the first speed.

Yet another embodiment of this invention is, in a chemo/electro-active material that exhibits an electrical response characteristic to a multi-component gas mixture containing a gaseous component, a method of increasing the sensitivity of the chemo/electro-active material that has a first sensitivity at a first concentration of the gaseous component, by reducing the concentration of the gaseous component to a second concentration at which the sensitivity of the chemo/electro-active material is increased to a second sensitivity that is greater than the first sensitivity; wherein the sensitivity of the chemo/electro-active material is the ratio given by ΔR/ΔC, where ΔR is the change in resistance, or in the size of a signal proportional to resistance, experienced by the chemo/electro-active material at a selected temperature as a result of a change in concentration of a component gas or subgroup of gases in the multi-component gas mixture, and ΔC is the change in concentration of the component gas or subgroup of gases. Stability and/or speed in relation to an electrical response characteristic may also be increased by this method.

### DESCRIPTION OF THE DRAWINGS

FIG. 1 depicts an array of chemo/electro-active materials.

FIG. 2 is a schematic of the pattern of interdigitated electrodes overlaid with a dielectric overlayer, forming sixteen blank wells, in an array of chemo/electro-active materials.

FIG. 3 depicts the electrode pattern, dielectric pattern, and sensor material pattern in an array of chemo/electro-active materials.

### DETAILED DESCRIPTION OF THE INVENTION

The present invention is a method and apparatus for directly sensing one or more analyte gases in a multi-component gas system under variable temperature conditions. By “directly sensing” is meant that an array of gas-sensing materials will be exposed to a mixture of gases that constitutes a multi-component gas system, such as in a stream of flowing gases. The array may be situated within the gas mixture, and more particularly within the source of the gas mixture, if desired. Alternatively, the array may reside in a chamber to which the gas mixture is directed from its source at another location. When gas is directed to a chamber in which an array is located, the gas mixture may be inserted in and removed from the chamber by piping, conduits or any other suitable gas transmission equipment.

A response may be obtained upon exposure of the gas-sensing materials to the multi-component gas mixture, and the response will be a function of the concentrations of one or more of the analyte gases themselves in the gas mixture. The sensor materials will be exposed simultaneously (or substantially simultaneously) to each of the analyte gases, and an analyte gas does not have to be physically separated from the multi-component gas mixture to be able to conduct an analysis of the mixture and/or one or more analyte components thereof. This invention can be used, for example, to obtain responses to, and thus to detect and/or measure the concentrations, of combustion gases, such as oxygen, carbon monoxide, nitrogen oxides, hydrocarbons such as butane, CO₂, H₂S, sulfur dioxide, halogens, hydrogen, water vapor, an organo-phosphorus gas, and ammonia, at variable temperatures in gas mixtures such as automobile emissions.

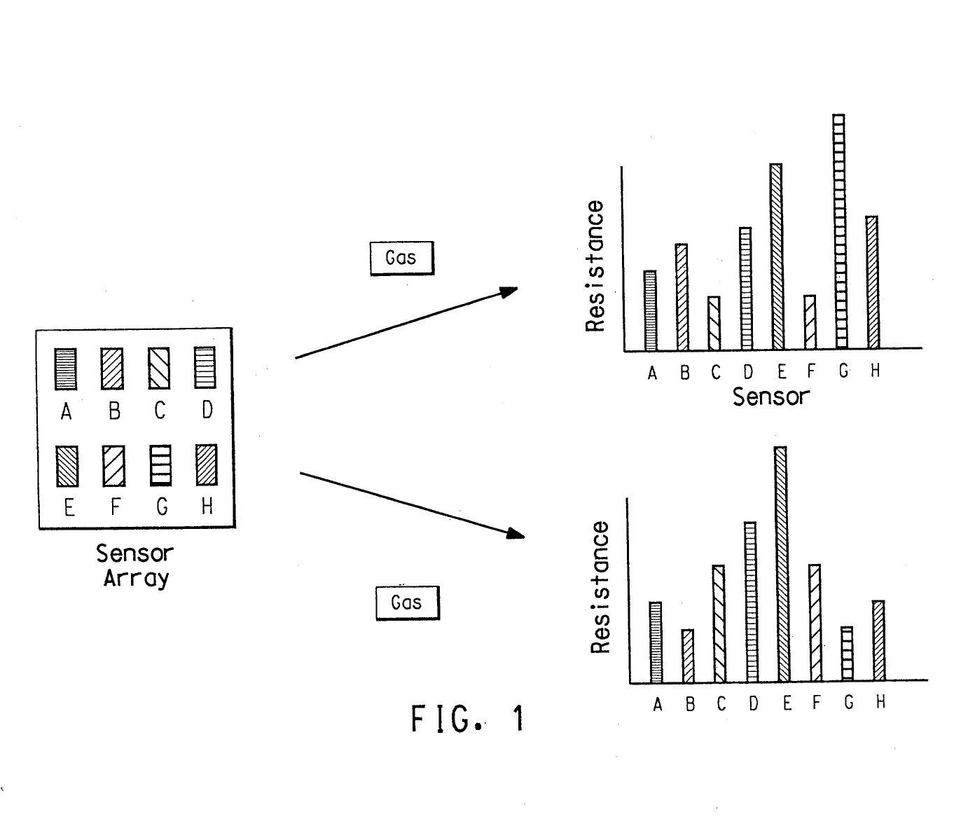

This invention utilizes an array of sensing materials to analyze a gas mixture and/or the components thereof to, for example, obtain a response to, detect the presence of and/or calculate the concentration of one or more individual analyte gas components in the system. By “array” is meant at least two different materials that are spatially separated, as shown for example in FIG. 1. The array may contain, for example, 3, 4, 5, 6, 8, 10 or 12 gas-sensing materials, or other greater or lesser numbers as desired. It is preferred that there be provided at least one sensor material for each of the individual gases or subgroups of gases in the mixture to be analyzed. It may be desirable, however, to provide more than one sensor material that is responsive to an individual gas component and/or a particular subgroup of gases in the mixture. For example, a group of at least 2, 3, 4, 5, 6, 7, 8, 9, 10, 11 or 12 sensors could be used to detect the presence of, and/or calculate the concentration of, one or more individual component gases and/or one or more subgroups of gases in the mixture. Groups of sensors, which may or may not have members in common, could be used to obtain a response to an analyte that is an individual gas component or a subgroup of gases in the mixture. A subgroup of gases that is, as the subgroup, an analyte may or may not contain as a member an individual gas that is itself also an analyte.

This invention is useful for detecting those gases that are expected to be present in a gas stream. For example, in a combustion process, gases that are expected to be present include oxygen, nitrogen oxides (such as NO NO₂, N₂0 or N₂O₄), carbon monoxide, hydrocarbons (such as CₙH₂ₙ₊₂, and as same may be saturated or unsaturated, or be optionally substituted with hetero atoms; and cyclic and aromatic analogs thereof), ammonia or hydrogen sulfide, sulfur dioxide, CO₂, or methanol. Other gases of interest may include alcohol vapors, solvent vapors, hydrogen, water vapor, and those deriving from saturated and unsaturated hydrocarbons, ethers, ketones, aldehydes, carbonyls, biomolecules and microorganisms. The component of a multi-component gas mixture that is an analyte of interest may be an individual gas such as carbon monoxide; may be a subgroup of some but not all of the gases contained in the mixture, such as the nitrogen oxides (NOₓ) or hydrocarbons; or may be a combination of one or more individual gases and one or more subgroups. When a subgroup of gases is an analyte, a chemo/electro-active material will respond to the collective concentration within a multi-component gas mixture of the members of the subgroup together.

The analyte gas(es) contained in the mixture to which the chemo/electro-active material will be exposed can be a single gas, a subgroup of gases together, or one or more gases or subgroups mixed with an inert gas such as nitrogen. Particular gases of interest are donor and acceptor gases. These are gases that either donate electrons to the semiconducting material, such as carbon monoxide, H₂S and hydrocarbons, or accept electrons from the semiconducting material, such as O₂, nitrogen oxides (commonly depicted as NOₓ), and halogens. When exposed to a donor gas, an n-type semiconducting material will have a decrease in electrical resistance, increasing the current, and it, therefore, will show an increase in temperature due to I²R heating. When exposed to an acceptor gas, an n-type semiconducting material will have an increase in electrical resistance, decreasing the current, and therefore will show a decrease in temperature due to I²R heating. The opposite occurs in each instance with p-type semiconducting materials.

Obtaining information related to the compositional content of a gas mixture using these sensor materials, such as measurement of gas concentrations, can be based on a change in an electrical property, such as AC impedance, of at least one, but preferably each and all, of the materials upon exposure of the materials to a mixture containing one or more analyte gases. Analysis of a gas mixture can also be performed in terms of extent of change in other electrical properties of the sensor materials, such as capacitance, voltage, current or AC or DC resistance. Change in DC resistance may be determined, for example, by measuring change in temperature at constant voltage. The change in one of these illustrative properties of a sensor material is a function of the partial pressure of an analyte gas within the gas mixture, which in turn determines the concentration at which the molecules of the analyte gases become adsorbed on the surface of a sensor material, thus affecting the electrical response characteristics of that material. By using an array of chemo/electro-active materials, a pattern of the respective responses exhibited by the materials upon exposure to a mixture containing one or more analyte gases can be used to simultaneously and directly detect the presence of, and/or measure the concentration of, at least one gas in a multi-component gas system. The invention, in turn, can be used to determine the composition of the gas system. The concept is illustrated schematically in FIG. 1 and is exemplified below.

To illustrate, consider the theoretical example below of the exposure of a sensor material to a mixture containing an analyte gas. Where a response is obtained, the event is depicted as positive (+), and where no response is obtained, the event is depicted as negative (−). Material 1 responds to Gas 1 and Gas 2, but shows no response to Gas 3. Material 2 responds to Gas 1 and Gas 3, but shows no response to Gas 2, and Material 3 responds to Gas 2 and Gas 3, but shows no response to Gas 1.

| | Material 1 | Material 2 | Material 3 |
|---|---|---|---|
| Gas 1 | + | + | − |
| Gas 2 | + | − | + |
| Gas 3 | − | + | + |

Therefore, if an array consisting of Materials 1, 2 and 3 gives the following response to an unknown gas,

| | Material 1 | Material 2 | Material 3 |
|---|---|---|---|
| Unknown Gas | + | − | + |

then the unknown gas would be identified as Gas 2. The response of each sensor material would be a function of the partial pressure within the mixture of, and thus the concentration of, an analyte gas or the collective concentration of a subgroup of analyte gases; and the response could be quantified or recorded as a processible value, such as a numerical value. In such case, the values of one or more responses can be used to generate quantitative information about the presence within the mixture of one or more analyte gases. In a multicomponent gas system, chemometrics, neural networks or other pattern recognition techniques could be used to calculate the concentration of one or more analyte gases in the mixture of the system.

The sensing materials used are chemo/electro-active materials. A “chemo/electro-active material” is a material that has an electrical response to at least one individual gas in a mixture. Some metal oxide semiconducting materials, mixtures thereof, or mixtures of metal oxide semiconductors with other inorganic compounds are chemo/electro-active, and are particularly useful in this invention. Each of the various chemo/electro-active materials used herein preferably exhibits an electrically-detectable response of a different kind and/or extent, upon exposure to the mixture and/or an analyte gas, than each of the other chemo/electro-active materials. As a result, an array of appropriately chosen chemo/electro-active materials can be used to analyze a multi-component gas mixture, such as by interacting with an analyte gas, sensing an analyte gas, or determining the presence and/or concentration of one or more analyte gases or subgroups in a mixture, despite the presence therein of interfering gases that are not of interest. Preferably the mole percentages of the major components of each gas-sensing material differs from that of each of the others.

The chemo/electro-active material can be of any type, but especially useful are semiconducting metal oxides such as SnO₂, TiO₂, WO₃ and ZnO. These particular materials are advantageous due to their chemical and thermal stability. The chemo/electro-active material can be a mixture of two or more semiconducting materials, or a mixture of a semiconducting material with an inorganic material, or combinations thereof. The semiconducting materials of interest can be deposited on a suitable solid substrate that is an insulator such as, but not limited to, alumina or silica and is stable under the conditions of the multi-component gas mixture. The array then takes the form of the sensor materials as deposited on the substrate. Other suitable sensor materials include single crystal or polycrystalline semiconductors of the bulk or thin film type, amorphous semiconducting materials, and semiconductor materials that are not composed of metal oxides.

The chemo/electro-active materials that contain more than one metal do not have to be a compound or solid solution, but can be a multi-phase physical mixture of discrete metals and/or metal oxides. As there will be varying degrees of solid state diffusion by the precursor materials from which the chemo/electro-active materials are formed, the final materials may exhibit composition gradients, and they can be crystalline or amorphous. Suitable metal oxides are those that

i) when at a temperature of about 400° C. or above, have a resistivity of about 1 to about 10⁶ ohm-cm, preferably about 1 to about 10⁵ ohm-cm, and more preferably about 10 to about 10⁴ ohm-cm;

ii) show a chemo/electro response to at least one gas of interest; and

iii) are stable and have mechanical integrity, that is are able to adhere to the substrate and not degrade at the operating temperature.

The metal oxides may also contain minor or trace amounts of hydration and elements present in the precursor materials.

The sensor materials may optionally contain one or more additives to promote adhesion to a substrate, or that alter the conductance, resistance or selectivity of the sensor material. Examples of additives to alter the conductance, resistance or selectivity of the sensor material include Ag, Au or Pt, as well as frits. Examples of additives to promote adhesion include frits, which are finely ground inorganic minerals that are transformed into glass or enamel on heating, or a rapidly quenched glass that retains its amorphous quality in the solid state. Frit percursor compounds are melted at high temperature and quenched, usually by rapidly pouring the melt into a fluid such as water, or by pouring through spinning metal rollers. The precursor compounds usually are a mechanical mixture of solid compounds such as oxides, nitrates or carbonates, or can be co-precipitated or gelled from a solution. Suitable precursor materials for frits include alkali and alkaline earth aluminosilicates and alumino-boro-silicates, copper, lead, phosphorus, titanium, zinc and zirconium. Frits as additives may be used in amounts of up to 30 volume percent, and preferably up to 10 volume percent, of the total volume of the chemo/electro-active material from which the sensor is made.

If desired, the sensor materials may also contain additives that, for example, catalyze the oxidation of a gas of interest or promote the selectivity for a particular analyte gas; or contain one or more dopants that convert an n semiconductor to a p semiconductor, or vice versa. These additives may be used in amounts of up to 30 weight percent, and preferably up to 10 weight percent, of the chemo/electro-active material from which the sensor is made.

Any frits or other additives used need not be uniformly or homogeneously distributed throughout the sensor material as fabricated, but may be localized on or near a particular surface thereof as desired. Each chemo/electro-active material may, if desired, be covered with a porous dielectric overlayer.

The chemo/electro-active materials used as sensor materials in this invention may, for example, be metal oxides of the formula M¹Oₓ, M¹ₐM²_{b}Oₓ, or M¹ₐM²_{b}M³_{c}Oₓ; or mixtures thereof, wherein

M¹, M² and M³ are metals that form stable oxides when fired in the presence of oxygen above 500° C.;

M¹ is selected from Periodic Groups 2-15 and the lanthanide group;

M² and M³ are each independently selected from Periodic Groups 1-15 and the lanthanide group;

M¹ and M² are not the same in M¹ₐM²_{b}Oₓ, and M¹, M² and M³ are not the same in M¹ₐM²_{b}M³_{c}Oₓ;

a, b, and c are each independently in the range of about 0.0005 to about 1; and

x is a number sufficient so that the oxygen present balances the charges of the other elements present in the chemo/elelctro-active material.

In certain preferred embodiments, the metal oxide materials may include those in which

M¹ is selected from the group consisting of Ce, Co, Cu, Fe, Ga, Nb, Ni, Pr, Ru, Sn, Ti, Tm, W, Yb, Zn, and Zr; and/or

M² and M³ are each independently selected from the group consisting of Al, Ba, Bi, Ca, Cd, Ce, Co, Cr, Cu, Fe, Ga, Ge, In, K, La, Mg, Mn, Mo, Na, Nb, Ni, Pb, Pr, Rb, Ru, Sb, Sc, Si, Sn, Sr, Ta, Ti, Tm, V, W, Y, Yb, Zn, and Zr;

but in which M¹ and M² are not the same in M¹ₐM²_{b}Oₓ, and M¹, M² and M³ are not the same in M¹ₐM²_{b}M³_{c}Oₓ.

In certain other preferred embodiments, the metal oxide materials may include those in which

M¹Oₓ is CeOₓ, CoOₓ, CuOₓ, FeOₓ, GaOₓ, NbOₓ, NiOₓ, PrOₓ, RuOₓ, SnOₓ, TaOₓ, TiOₓ, TmOₓ, WOₓ, YbOₓ, ZnOₓ, ZrOₓ, SnOₓ with Ag additive, ZnOₓ with Ag additive, TiOₓ with Pt additive, ZnOₓ with frit additive, NiOₓ with frit additive, SnOₓ with frit additive, or WOₓ with frit additive; and/or

M¹ₐM²_{b}Oₓ is AlₐCr_{b}Oₓ, AlₐFe_{b}Oₓ, AlₐMg_{b}Oₓ, AlₐNi_{b}Oₓ, AlₐTi_{b}Oₓ, AlₐV_{b}Oₓ, BaₐCu_{b}Oₓ, BaₐSn_{b}Oₓ, BaₐZn_{b}Oₓ, BiₐRu_{b}Oₓ, BiₐSn_{b}Oₓ, BiaZn_{b}Oₓ, CaₐSn_{b}Oₓ, CaₐZn_{b}Oₓ, CdₐSn_{b}Oₓ, CdₐZn_{b}Oₓ, CeₐFe_{b}Oₓ, CeₐNb_{b}Oₓ, CeₐTi_{b}Oₓ, CeₐV_{b}Oₓ, CoₐCu_{b}Oₓ, CoₐGe_{b}Oₓ, CoₐLa_{b}Oₓ, CoₐMg_{b}Oₓ, CoₐNb_{b}Oₓ, CoₐPb_{b}Oₓ, CoₐSn_{b}Oₓ, CoₐV_{b}Oₓ, CoₐW_{b}Oₓ, CoₐZn_{b}Oₓ, CrₐCu_{b}Oₓ, CrₐLa_{b}Oₓ, CrₐMn_{b}Oₓ, CrₐNi_{b}Oₓ, CrₐSi_{b}Oₓ, CrₐTi^{b}Oₓ, CrₐY_{b}Oₓ, CrₐZn_{b}Oₓ, CuₐFe_{b}Oₓ, CuₐGa_{b}Oₓ, CuₐLa_{b}Oₓ, CuₐNa_{b}Oₓ, CuₐNi_{b}Oₓ, CuₐPb_{b}Oₓ, CuₐSn_{b}Oₓ, CuₐSr_{b}Oₓ, CuₐTi_{b}Oₓ, CuₐZn_{b}Oₓ, CuₐZr_{b}Oₓ, FeₐGa_{b}Oₓ, FeₐLa_{b}Oₓ, FeₐMo_{b}Oₓ, FeₐNb_{b}Oₓ, FeₐNi_{b}Oₓ, FeₐSn_{b}Oₓ, FeₐTi_{b}Oₓ, FeₐW_{b}Oₓ, FeₐZn_{b}Oₓ, FeₐZr_{b}Oₓ, GaₐLa_{b}Oₓ, GaₐSn_{b}Oₓ, GeₐNb_{b}Oₓ, GeₐTi_{b}Oₓ, InₐSn_{b}Oₓ, KₐNb_{b}Oₓ, MnₐNb_{b}Oₓ, MnₐSn_{b}Oₓ, MnₐTi_{b}Oₓ, MnₐY_{b}Oₓ, MnₐZn_{b}Oₓ, MoₐPb_{b}Oₓ, MoₐRb_{b}Oₓ, MoₐSn_{b}Oₓ, MoₐTi_{b}Oₓ, MoₐZn_{b}Oₓ, NbₐNi_{b}Oₓ, NbₐNi_{b}Oₓ, NbₐSr_{b}Oₓ, NbₐTi_{b}Oₓ, NbₐW_{b}Oₓ, NbₐZr_{b}Oₓ, NiₐSi_{b}Oₓ, NiₐSn_{b}Oₓ, NiₐY_{b}Oₓ, NiₐZn_{b}Oₓ, NiₐZr_{b}Oₓ, PbₐSn_{b}Oₓ, PbₐZn_{b}Oₓ, RbₐW_{b}Oₓ, RuₐSn_{b}Oₓ, RuₐW_{b}Oₓ, RuₐZn_{b}Oₓ, SbₐSn_{b}Oₓ, SbₐZn_{b}Oₓ, ScₐZr_{b}Oₓ, SiₐSn_{b}Oₓ, SiₐTi_{b}Oₓ, SiₐW_{b}Oₓ, SiₐZn_{b}Oₓ, SnₐTa_{b}Oₓ, SnₐTi_{b}Oₓ, SnₐW_{b}Oₓ, SnₐZn_{b}Oₓ, SnₐZr_{b}Oₓ, SrₐTi_{b}Oₓ, TaₐTi_{b}Oₓ, TaₐZn_{b}Oₓ, TaₐZr_{b}Oₓ, TiₐV_{b}Oₓ, TiₐW_{b}Oₓ, TiₐZn_{b}Oₓ, TiₐZr_{b}Oₓ, VₐZn_{b}Oₓ, VₐZr_{b}Oₓ, WₐZn_{b}Oₓ, WₐZr_{b}Oₓ, YₐZr_{b}Oₓ, ZnₐZr_{b}Oₓ, AlₐNi_{b}Oₓ with frit additive, CrₐTi_{b}Oₓ with frit additive, FeₐLa_{b}Oₓ with frit additive, FeₐNi_{b}Oₓ with frit additive, FeₐTi_{b}Oₓ with frit additive, NbₐTi_{b}Oₓ with frit additive, NbₐW_{b}Oₓ with frit additive, NiₐZn_{b}Oₓ with frit additive, NiₐZr_{b}Oₓ with frit additive, SbₐSn_{b}Oₓ with frit additive, TaₐTi_{b}Oₓ with frit additive, or TiₐZn_{b}Oₓ with frit additive; and/or

M¹ₐM²_{b}M³_{c}Oₓ is AlₐMg_{b}Zn_{c}Oₓ, AlₐSi_{b}V_{c}Oₓ, BaₐCu_{b}Ti_{c}Oₓ, CaₐCe_{b}Zr_{c}Oₓ, CoₐNi_{b}Ti_{c}Oₓ, CoₐNi_{b}Zr_{c}Oₓ, CoₐPb_{b}Sn_{c}Oₓ, CoₐPb_{b}Zn_{c}Oₓ, CrₐSr_{b}Ti_{c}Oₓ, CuₐFe_{b}Mn_{c}Oₓ, CuₐLa_{b}Sr_{c}Oₓ, FeₐNb_{b}Ti_{c}Oₓ, FeₐPb_{b}Zn_{c}Oₓ, FeₐSr_{b}Ti_{c}Oₓ, FeₐTa_{b}Ti_{c}Oₓ, FeₐW_{b}Zr_{c}Oₓ, GaₐTi_{b}Zn_{c}Oₓ, LaₐMn_{b}Na_{c}Oₓ, LaₐMn_{b}Sr_{c}Oₓ, MnₐSr_{b}Ti_{c}Oₓ, MoₐPb_{b}Zn_{c}Oₓ, NbₐSr_{b}Ti_{c}Oₓ, NbₐSr_{b}W_{c}Oₓ, NbₐTi_{b}Zn_{c}Oₓ, NiₐSr_{b}Ti_{c}Oₓ, SnₐW_{b}Zn_{c}Oₓ, SrₐTi_{b}V_{c}Oₓ, SrₐTi_{b}Zn_{c}Oₓ, or TiₐW_{b}Zr_{c}Oₓ.

In certain other preferred embodiments, the metal oxide materials may include those that are in an array of first and second chemo/electro-active materials, wherein the chemo/electro-active materials are selected from the pairings in the group consisting of

(i) the first material is M¹Oₓ, and the second material is M¹ₐM²_{b}Oₓ;

(ii) the first material is M¹Oₓ, and the second material is M¹ₐM²_{b}M³_{c}Oₓ;

(iii) the first material is M¹ₐM²_{b}Oₓ, and the second material is M¹ₐM²_{b}M³_{c}Oₓ;

(iv) the first material is a first M¹O_{X}, and the second material is a second M¹Oₓ;

(v) the first material is a first M¹ₐM²_{b}Oₓ, and the second material is a second M¹ₐM²_{b}Oₓ; and

(vi) the first material is a first M¹ₐM²_{b}M³_{c}Oₓ, and the second material is a second M¹ₐM²_{b}M³_{c}Oₓ; wherein

M¹ is selected from the group consisting of Ce, Co, Cu, Fe, Ga, Nb, Ni, Pr, Ru, Sn, Ti, Tm, W, Yb, Zn, and Zr;

M² and M³ are each independently selected from the group consisting of Al, Ba, Bi, Ca, Cd, Ce, Co, Cr, Cu, Fe, Ga, Ge, In, K, La, Mg, Mn, Mo, Na, Nb, Ni, Pb, Pr, Rb, Ru, Sb, Sc, Si, Sn, Sr, Ta, Ti, Tm, V, W, Y, Yb, Zn, and Zr;

but M¹ and M² are not the same in M¹ₐM²_{b}Oₓ, and M¹, M² and M³ are not the same in M¹ₐM²_{b}M³_{c}Oₓ;

a, b and c are each independently about 0.0005 to about 1; and

x is a number sufficient so that the oxygen present balances the charges of the other elements present in the chemo/electro-active material.

In certain other preferred embodiments, an array of two or more chemo/electro-active materials may be selected from the group consisting of (i) the chemo/electro-active materials that include M¹Oₓ, (ii) the chemo/electro-active materials that include M¹ₐM²_{b}Oₓ and (iii) the chemo/electro-active materials that include M¹ₐM²_{b}M³_{c}Oₓ;

wherein M¹ is selected from the group consisting of Al, Ce, Cr, Cu, Fe, Ga, Mn, Nb, Ni, Pr, Sb, Sn, Ta, Ti, W and Zn;

wherein M² and M³ are each independently selected from the group consisting of Ga, La, Mn, Ni, Sn, Sr, Ti, W, Y, Zn;

wherein M¹ and M² are each different in M¹ₐM²_{b}Oₓ, and M¹, M² and M³ are each different in M¹ₐM²_{b}M³_{c}Oₓ;

wherein a, b and c are each independently about 0.0005 to about 1; and

wherein x is a number sufficient so that the oxygen present balances the charges of the other elements in the chemo/electro-active material.

M¹ may for example be selected from the group consisting of Al, Cr, Fe, Ga, Mn, Nb, Ni, Sb, Sn, Ta, Ti and Zn, or from the group consisting of Ga, Nb, Ni, Sb, Sn, Ta, Ti and Zn. M², M³, or M² and M³ may be selected from the group consisting of La, Ni, Sn, Ti and Zn, or the group consisting of Sn, Ti and Zn.

The array may contain other numbers of chemo/electro-active materials such as four or eight, and the array may contain at least one chemo/electro-active material that comprises M1Ox, and at least three chemo/electro-active materials that each comprise M1aM2bOx. Alternatively, the array may contain (i) at least one chemo/electro-active material that comprises M1Ox, and at least four chemo/electro-active materials that each comprise M1aM2bOx; or (ii) at least two chemo/electro-active materials that each comprise M1Ox, and at least four chemo/electro-active materials that each comprise M1aM2bOx; or (iii) at least three chemo/electro-active materials that each comprise M1aM2bOx, and at least one chemo/electro-active material that comprises M1aM2bM3cOx.

Chemo/electro-active materials useful in the apparatus of this invention may be selected from one or more members of the group consisting of a chemo/electro-active material that comprises AlₐNi_{b}Oₓ

a chemo/electro-active material that comprises CeO₂,

a chemo/electro-active material that comprises CrₐMn_{b}Oₓ,

a chemo/electro-active material that comprises CrₐTi_{b}Oₓ

a chemo/electro-active material that comprises CrₐY_{b}Oₓ

a chemo/electro-active material that comprises CuₐGa_{b}Oₓ,

a chemo/electro-active material that comprises CuₐLa_{b}Oₓ

a chemo/electro-active material that comprises CuO,

a chemo/electro-active material that comprises FeₐLa_{b}Oₓ

a chemo/electro-active material that comprises FeₐNi_{b}Oₓ

a chemo/electro-active material that comprises FeₐTi_{b}Oₓ

a chemo/electro-active material that comprises GaₐTi_{b}Zn_{c}Oₓ

a chemo/electro-active material that comprises MnₐTi_{b}Oₓ

a chemo/electro-active material that comprises NbₐSr_{b}Oₓ,

a chemo/electro-active material that comprises NbₐTi_{b}Oₓ

a chemo/electro-active material that comprises NbₐTi_{b}Zn_{c}Oₓ

a chemo/electro-active material that comprises NbₐW_{b}Oₓ

a chemo/electro-active material that comprises NiO,

a chemo/electro-active material that comprises NiₐZn_{b}Oₓ

a chemo/electro-active material that comprises Pr₆O₁₁,

a chemo/electro-active material that comprises SbₐSn_{b}Oₓ.

a chemo/electro-active material that comprises SnO₂,

a chemo/electro-active material that comprises TaₐTi_{b}Oₓ, and

a chemo/electro-active material that comprises TiₐZn_{b}Oₓ.

a chemo/electro-active material that comprises WO₃, and

a chemo/electro-active material that comprises ZnO.

wherein a, b and c are each independently about 0.0005 to about 1; and wherein x is a number sufficient so that the oxygen present balances the charges of the other elements in the chemo/electro-active material.

Chemo/electro-active materials useful in this invention may also be selected from subgroups of the foregoing formed by omitting any one or more members from the whole group as set forth in the list above. As a result, the chemo/electro-active materials may in such instance not only be any one or more member(s) selected from any subgroup of any size that may be formed from the whole group as set forth in the list above, but the subgroup may also exclude the members that have been omitted from the whole group to form the subgroup. The subgroup formed by omitting various members from the whole group in the list above may, moreover, contain any number of the members of the whole group such that those members of the whole group that are excluded to form the subgroup are absent from the subgroup. Representative subgroups are set forth below.

Chemo/electro-active materials that comprise M1Ox may, for example, be selected from the group consisting of

a chemo/electro-active material that comprises CeO₂,

a chemo/electro-active material that comprises CuO,

a chemo/electro-active material that comprises NiO,

a chemo/electro-active material that comprises Pr₆O₁₁,

a chemo/electro-active material that comprises SnO₂,

a chemo/electro-active material that comprises WO₃, and

a chemo/electro-active material that comprises ZnO.

Of the above, one or more members of the group consisting of

a chemo/electro-active material that comprises CeO₂,

a chemo/electro-active material that comprises SnO₂, and

a chemo/electro-active material that comprises ZnO

may contain a frit additive.

A chemo/electro-active material that comprises M1aM2bOx, or a chemo/electro-active material that comprises M1aM2bM3cOx, may be selected from the group consisting of

a chemo/electro-active material that comprises AlₐNi_{b}Oₓ

a chemo/electro-active material that comprises CrₐMn_{b}Oₓ,

a chemo/electro-active material that comprises CrₐTi_{b}Oₓ

a chemo/electro-active material that comprises CrₐY_{b}Oₓ

a chemo/electro-active material that comprises CuₐGa_{b}Oₓ,

a chemo/electro-active material that comprises CuₐLa_{b}Oₓ

a chemo/electro-active material that comprises FeₐLa_{b}Oₓ

a chemo/electro-active material that comprises FeₐNi_{b}Oₓ

a chemo/electro-active material that comprises FeₐTi_{b}Oₓ

a chemo/electro-active material that comprises GaₐTi_{b}Zn_{c}Oₓ

a chemo/electro-active material that comprises MnₐTi_{b}Oₓ

a chemo/electro-active material that comprises NbₐSr_{b}Oₓ,

a chemo/electro-active material that comprises NbₐTi_{b}Oₓ

a chemo/electro-active material that comprises NbₐTi_{b}Zn_{c}Oₓ

a chemo/electro-active material that comprises NbₐW_{b}Oₓ

a chemo/electro-active material that comprises NiₐZn_{b}Oₓ

a chemo/electro-active material that comprises SbₐSn_{b}Oₓ.

a chemo/electro-active material that comprises TaₐTi_{b}Oₓ, and

a chemo/electro-active material that comprises TiₐZn_{b}Oₓ.

of the above, one or more members of the group consisting of

a chemo/electro-active material that comprises AlₐNi_{b}Oₓ

a chemo/electro-active material that comprises CrₐTi_{b}Oₓ

a chemo/electro-active material that comprises CuₐLa_{b}Oₓ

a chemo/electro-active material that comprises FeₐLa_{b}Oₓ

a chemo/electro-active material that comprises FeₐNi_{b}Oₓ

a chemo/electro-active material that comprises FeₐTi_{b}Oₓ

a chemo/electro-active material that comprises GaₐTi_{b}Zn_{c}Oₓ

a chemo/electro-active material that comprises NbₐTi_{b}Oₓ

a chemo/electro-active material that comprises NbₐTi_{b}Zn_{c}Oₓ

a chemo/electro-active material that comprises NbₐW_{b}Oₓ

a chemo/electro-active material that comprises NiₐZn_{b}Oₓ

a chemo/electro-active material that comprises SbₐSn_{b}Oₓ

a chemo/electro-active material that comprises TaₐTi_{b}Oₓ, and

a chemo/electro-active material that comprises TiₐZn_{b}Oₓ

may contain a frit additive.

In the apparatus of this invention, a chemo/electro-active material that comprises M1aM2bOx may be selected from the group consisting of

a chemo/electro-active material that comprises AlₐNi_{b}Oₓ

a chemo/electro-active material that comprises CrₐTi_{b}Oₓ, and

a chemo/electro-active material that comprises FeₐLa_{b}Oₓ.

or the group consisting of

a chemo/electro-active material that comprises CrₐTi_{b}Oₓ

a chemo/electro-active material that comprises FeₐLa_{b}Oₓ, and

a chemo/electro-active material that comprises FeₐNi_{b}Oₓ

or the group consisting of

a chemo/electro-active material that comprises FeₐLa_{b}Oₓ

a chemo/electro-active material that comprises FeₐNi_{b}Oₓ, and

a chemo/electro-active material that comprises NiₐZn_{b}Oₓ

or the group consisting of

a chemo/electro-active material that comprises FeₐNi_{b}Oₓ

a chemo/electro-active material that comprises NiₐZn_{b}Oₓ, and

a chemo/electro-active material that comprises SbₐSn_{b}Oₓ.

or the group consisting of

a chemo/electro-active material that comprises AlₐNi_{b}Oₓ

a chemo/electro-active material that comprises CrₐTi_{b}Oₓ

a chemo/electro-active material that comprises FeₐLa_{b}Oₓ

a chemo/electro-active material that comprises FeₐNi_{b}Oₓ

a chemo/electro-active material that comprises NiₐZn_{b}Oₓ, and

a chemo/electro-active material that comprises SbₐSn_{b}Oₓ.

or the group consisting of

a chemo/electro-active material that comprises AlₐNi_{b}Oₓ

a chemo/electro-active material that comprises CrₐTi_{b}Oₓ, and

a chemo/electro-active material that comprises MnₐTi_{b}Oₓ

or the group consisting of

a chemo/electro-active material that comprises NbₐTi_{b}Oₓ

a chemo/electro-active material that comprises NiₐZn_{b}Oₓ, and

a chemo/electro-active material that comprises SbₐSn_{b}Oₓ

or the group consisting of

a chemo/electro-active material that comprises NiₐZn_{b}Oₓ

a chemo/electro-active material that comprises SbₐSn_{b}Oₓ, and

a chemo/electro-active material that comprises TaₐTi_{b}Oₓ

or the group consisting of

a chemo/electro-active material that comprises SbₐSn_{b}Oₓ

a chemo/electro-active material that comprises TaₐTi_{b}Oₓ, and

a chemo/electro-active material that comprises TiₐZn_{b}Oₓ.

or the group consisting of

a chemo/electro-active material that comprises CrₐMn_{b}Oₓ

a chemo/electro-active material that comprises CrₐTi_{b}Oₓ, and

a chemo/electro-active material that comprises CrₐY_{b}Oₓ

or the group consisting of

a chemo/electro-active material that comprises CrₐTi_{b}Oₓ

a chemo/electro-active material that comprises CrₐY_{b}Oₓ, and

a chemo/electro-active material that comprises CuₐGa_{b}Oₓ

or the group consisting of

a chemo/electro-active material that comprises CrₐY_{b}Oₓ

a chemo/electro-active material that comprises CuₐGa_{b}Oₓ, and

a chemo/electro-active material that comprises CuₐLa_{b}Oₓ

or the group consisting of

a chemo/electro-active material that comprises CuₐGa_{b}Oₓ

a chemo/electro-active material that comprises CuₐLa_{b}Oₓ, and

a chemo/electro-active material that comprises FeₐLa_{b}Oₓ.

or the group consisting of

a chemo/electro-active material that comprises CrₐMn_{b}Oₓ

a chemo/electro-active material that comprises CrₐTi_{b}Oₓ

a chemo/electro-active material that comprises CrₐY_{b}Oₓ

a chemo/electro-active material that comprises CuₐGa_{b}Oₓ

a chemo/electro-active material that comprises CuₐLa_{b}Oₓ, and

a chemo/electro-active material that comprises FeₐLa_{b}Oₓ

or the group consisting of

a chemo/electro-active material that comprises CrₐY_{b}Oₓ

a chemo/electro-active material that comprises CuₐGa_{b}Oₓ, and

a chemo/electro-active material that comprises CuₐLa_{b}Oₓ

or the group consisting of

a chemo/electro-active material that comprises CuₐGa_{b}Oₓ,

a chemo/electro-active material that comprises CuₐLa_{b}Oₓ, and

a chemo/electro-active material that comprises FeₐTi_{b}Oₓ

or the group consisting of

a chemo/electro-active material that comprises CrₐMn_{b}Oₓ

a chemo/electro-active material that comprises MnₐTi_{b}Oₓ, and

a chemo/electro-active material that comprises NbₐSr_{b}Oₓ

In the apparatus of this invention, a chemo/electro-active material that comprises M1aM2bOx, or a chemo/electro-active material that comprises M1aM2bM3cOx, may be selected from the group consisting of

a chemo/electro-active material that comprises CrₐTi_{b}Oₓ

a chemo/electro-active material that comprises MnₐTi_{b}Oₓ, and

a chemo/electro-active material that comprises NbₐTi_{b}Zn_{c}Oₓ

or the group consisting of

a chemo/electro-active material that comprises MnₐTi_{b}Oₓ

a chemo/electro-active material that comprises NbₐTi_{b}Zn_{c}Oₓ, and

a chemo/electro-active material that comprises TaₐTi_{b}Oₓ

or the group consisting of

a chemo/electro-active material that comprises NbₐTi_{b}Zn_{c}Oₓ

a chemo/electro-active material that comprises TaₐTi_{b}Oₓ, and

a chemo/electro-active material that comprises TiₐZn_{b}Oₓ.

or the group consisting of

a chemo/electro-active material that comprises AlₐNi_{b}Oₓ

a chemo/electro-active material that comprises CrₐTi_{b}Oₓ

a chemo/electro-active material that comprises MnₐTi_{b}Oₓ

a chemo/electro-active material that comprises NbₐTi_{b}Zn_{c}Oₓ

a chemo/electro-active material that comprises TaₐTi_{b}Oₓ, and

a chemo/electro-active material that comprises TiₐZn_{b}Oₓ.

or the group consisting of

a chemo/electro-active material that comprises GaₐTi_{b}Zn_{c}Oₓ

a chemo/electro-active material that comprises NbₐTi_{b}Oₓ, and

a chemo/electro-active material that comprises NiₐZn_{b}Oₓ

or the group consisting of

a chemo/electro-active material that comprises GaₐTi_{b}Zn_{c}Oₓ

a chemo/electro-active material that comprises NbₐTi_{b}Oₓ

a chemo/electro-active material that comprises NiₐZn_{b}Oₓ

a chemo/electro-active material that comprises SbₐSn_{b}Oₓ

a chemo/electro-active material that comprises TaₐTi_{b}Oₓ, and

a chemo/electro-active material that comprises TiₐZn_{b}Oₓ.

or the group consisting of

a chemo/electro-active material that comprises CuₐLa_{b}Oₓ

a chemo/electro-active material that comprises FeₐTi_{b}Oₓ, and

a chemo/electro-active material that comprises GaₐTi_{b}Zn_{c}Oₓ

or the group consisting of

a chemo/electro-active material that comprises FeₐTi_{b}Oₓ

a chemo/electro-active material that comprises GaₐTi_{b}Zn_{c}Oₓ, and

a chemo/electro-active material that comprises NbₐW_{b}Oₓ.

or the group consisting of

a chemo/electro-active material that comprises CrₐY_{b}Oₓ

a chemo/electro-active material that comprises CuₐGa_{b}Oₓ,

a chemo/electro-active material that comprises CuₐLa_{b}Oₓ

a chemo/electro-active material that comprises FeₐTi_{b}Oₓ

a chemo/electro-active material that comprises GaₐTi_{b}Zn_{c}Oₓ, and

a chemo/electro-active material that comprises NbₐW_{b}Oₓ.

or the group consisting of

a chemo/electro-active material that comprises MnₐTi_{b}Oₓ

a chemo/electro-active material that comprises NbₐSr_{b}Oₓ, and

a chemo/electro-active material that comprises NbₐTi_{b}Zn_{c}Oₓ

In the apparatus of this invention, a chemo/electro-active material that comprises M1Ox, a chemo/electro-active material that comprises M1aM2bOx, or a chemo/electro-active material that comprises M1aM2bM3cOx, may be selected from the group consisting of

a chemo/electro-active material that comprises GaₐTi_{b}Zn_{c}Oₓ

a chemo/electro-active material that comprises NbₐTi_{b}Oₓ

a chemo/electro-active material that comprises NiₐZn_{b}Oₓ, and

a chemo/electro-active material that comprises SnO₂

or the group consisting of

a chemo/electro-active material that comprises GaₐTi_{b}Zn_{c}Oₓ

a chemo/electro-active material that comprises NbₐTi_{b}Oₓ

a chemo/electro-active material that comprises NiₐZn_{b}Oₓ

a chemo/electro-active material that comprises SnO₂,

a chemo/electro-active material that comprises TaₐTi_{b}Oₓ, and

a chemo/electro-active material that comprises TiₐZn_{b}Oₓ.

or the group consisting of

a chemo/electro-active material that comprises NbₐSr_{b}Oₓ

a chemo/electro-active material that comprises NbₐTi_{b}Zn_{c}Oₓ, and

a chemo/electro-active material that comprises Pr₆O₁₁

or the group consisting of

a chemo/electro-active material that comprises NbₐTi_{b}Zn_{c}Oₓ

a chemo/electro-active material that comprises Pr₆O₁₁, and

a chemo/electro-active material that comprises TiₐZn_{b}Oₓ

or the group consisting of

a chemo/electro-active material that comprises CrₐMn_{b}Oₓ

a chemo/electro-active material that comprises MnₐTi_{b}Oₓ

a chemo/electro-active material that comprises NbₐSr_{b}Oₓ

a chemo/electro-active material that comprises NbₐTi_{b}Zn_{c}Oₓ

a chemo/electro-active material that comprises Pr₆O₁₁, and

a chemo/electro-active material that comprises TiₐZn_{b}Oₓ.

In the apparatus of this invention, a chemo/electro-active material that comprises M1Ox, or a chemo/electro-active material that comprises M1aM2bOx may be selected from the group consisting of

a chemo/electro-active material that comprises NbₐTi_{b}Oₓ

a chemo/electro-active material that comprises NiₐZn_{b}Oₓ, and

a chemo/electro-active material that comprises SnO₂.

or the group consisting of

a chemo/electro-active material that comprises NiₐZn_{b}Oₓ

a chemo/electro-active material that comprises SnO₂, and

a chemo/electro-active material that comprises TaₐTi_{b}Oₓ

or the group consisting of

a chemo/electro-active material that comprises SnO₂,

a chemo/electro-active material that comprises TaₐTi_{b}Oₓ, and

a chemo/electro-active material that comprises TiₐZn_{b}Oₓ.

or the group consisting of

a chemo/electro-active material that comprises NbₐTi_{b}Oₓ

a chemo/electro-active material that comprises NiₐZn_{b}Oₓ

a chemo/electro-active material that comprises SbₐSn_{b}Oₓ, and

a chemo/electro-active material that comprises ZnO.

or the group consisting of

a chemo/electro-active material that comprises NiₐZn_{b}Oₓ

a chemo/electro-active material that comprises SbₐSn_{b}Oₓ

a chemo/electro-active material that comprises TaₐTi_{b}Oₓ, and

a chemo/electro-active material that comprises ZnO

or the group consisting of

a chemo/electro-active material that comprises SbₐSn_{b}Oₓ

a chemo/electro-active material that comprises TaₐTi_{b}Oₓ

a chemo/electro-active material that comprises TiₐZn_{b}Oₓ, and

a chemo/electro-active material that comprises ZnO

or the group consisting of

a chemo/electro-active material that comprises TaₐTi_{b}Oₓ

a chemo/electro-active material that comprises TiₐZn_{b}Oₓ, and

a chemo/electro-active material that comprises ZnO.

or the group consisting of

a chemo/electro-active material that comprises NbₐTi_{b}Oₓ

a chemo/electro-active material that comprises NiₐZn_{b}Oₓ

a chemo/electro-active material that comprises SbₐSn_{b}Oₓ

a chemo/electro-active material that comprises TaₐTi_{b}Oₓ

a chemo/electro-active material that comprises TiₐZn_{b}Oₓ, and

a chemo/electro-active material that comprises ZnO.

or the group consisting of

a chemo/electro-active material that comprises AlₐNi_{b}Oₓ

a chemo/electro-active material that comprises CrₐMn_{b}Oₓ, and

a chemo/electro-active material that comprises CuO

or the group consisting of

a chemo/electro-active material that comprises CrₐMn_{b}Oₓ

a chemo/electro-active material that comprises CuO, and

a chemo/electro-active material that comprises NbₐSr_{b}Oₓ

or group consisting of

a chemo/electro-active material that comprises CuO

a chemo/electro-active material that comprises NbₐSr_{b}Oₓ, and

a chemo/electro-active material that comprises Pr₆O₁₁

or group consisting of

a chemo/electro-active material that comprises NbₐSr_{b}Oₓ

a chemo/electro-active material that comprises Pr₆O₁₁, and

a chemo/electro-active material that comprises WO₃.

or group consisting of

a chemo/electro-active material that comprises AlₐNi_{b}Oₓ

a chemo/electro-active material that comprises CrₐMn_{b}Oₓ

a chemo/electro-active material that comprises CuO

a chemo/electro-active material that comprises NbₐSr_{b}Oₓ

a chemo/electro-active material that comprises Pr₆O₁₁, and

a chemo/electro-active material that comprises WO₃.

Any method of depositing the chemo/electro-active material to a substrate is suitable. One technique used for deposition is applying a semiconducting material on an alumina substrate on which electrodes are screen printed. The semiconducting material can be deposited on top of electrodes by hand painting semiconducting materials onto the substrate, pipetting materials into wells, thin film deposition, or thick film printing techniques. Most techniques are followed by a final firing to sinter the semiconducting materials.

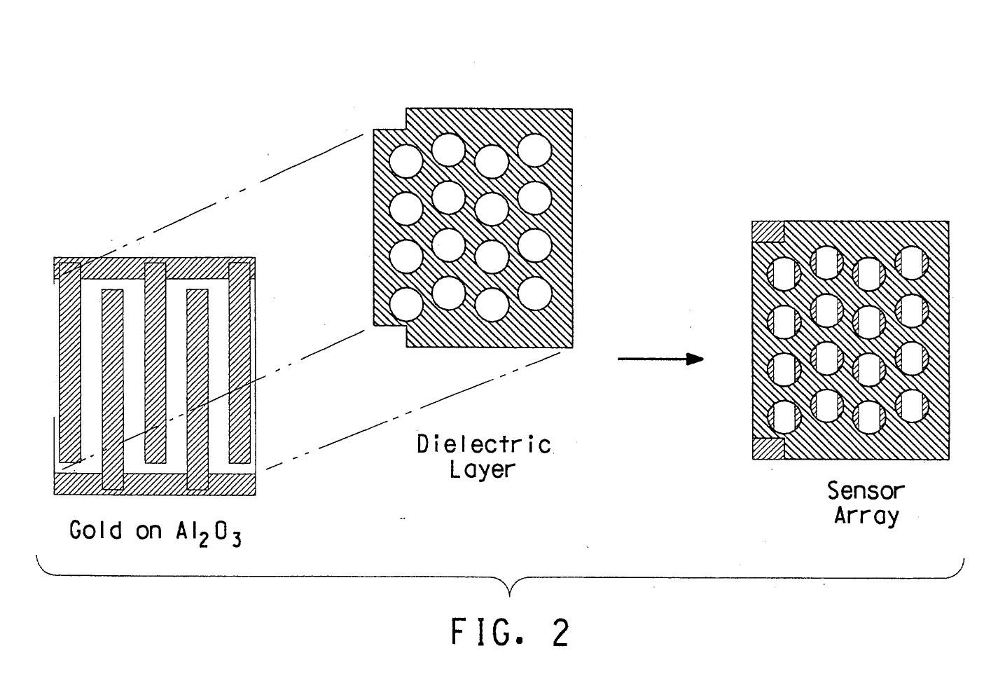

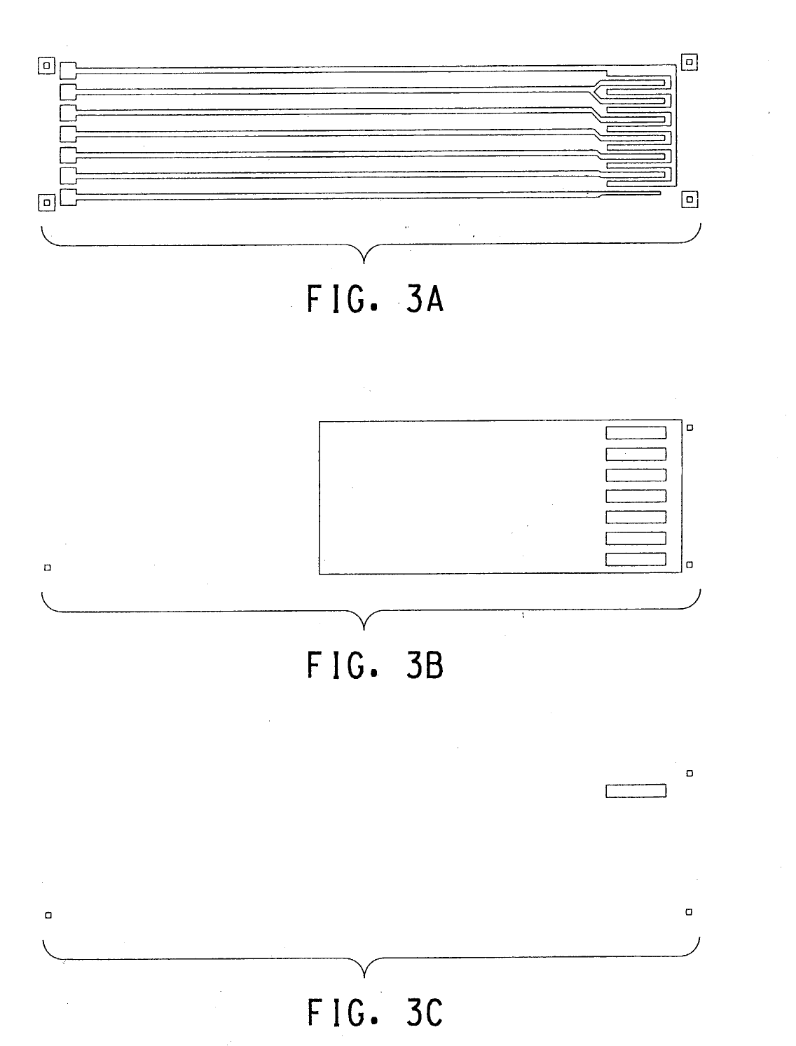

Techniques for screen-printing substrates with the electrodes and chemo/electro-active materials are illustrated in FIGS. 2-3. FIG. 2 depicts a method of using interdigitated electrodes overlaid with dielectric material, forming blank wells into which the chemo/electro-active materials can be deposited. FIG. 3 depicts an electrode screen pattern for an array of 6 materials which is printed on both sides of the substrate to provide for a 12-material array chip. Two of the electrodes are in parallel so it holds only 6 unique materials. Counting down from the top of the array shown in FIG. 3, the top two materials can only be accessed simultaneously by the split electrode with which they have shared contact. Below that is the screen pattern for the dielectric material, which is screen printed on top of the electrodes on both sides of the substrate to prevent the material from being fouled by contact with the gas mixture, such as a deposit of soot that could reduce the sensitivity of a sensor material to a gas or cause a short. Below that is the screen pattern for the actual sensor materials. This is printed in the holes in the dielectric on top of the electrodes. When more than one material is used in the array, the individual materials are printed one at a time.

The geometry of a sensor material as fabricated in an array, including such characteristics as its thickness, selection of a compound or composition for use as the sensor, and the voltage applied across the array, can vary depending on the sensitivity required. If desired, the apparatus may be constructed in a size such that it may be passed through an opening that is the size of a circle having a diameter of no more than about 150 mm, or no more than about 100 mm, or no more than about 50 mm, or no more than about 25 mm, or no more than about 18 mm, as the requirements of it usage may dictate. The sensor materials are preferably connected in parallel in a circuit to which a voltage of about 1 to about 20, preferably about 1 to about 12, volts is applied across the sensor materials.

As noted, the types of electrical response characteristics that may be measured include AC impedance or resistance, capacitance, voltage, current or DC resistance. It is preferred to use resistance as the electric response characteristic of a sensor material that is measured to perform analysis of a gas mixture and/or a component therein. For example, a suitable sensor material may be that which, when at a temperature of about 400° C. or above, has a resistivity of at least about 1 ohm-cm, and preferably at least about 10 ohm-cm, and yet no more than about 10⁶ ohm-cm, preferably no more than about 10⁵ ohm-cm, and more preferably no more than about 10⁴ ohm-cm. Such a sensor material may also be characterized as that which exhibits, preferably at a temperature of about 400° C. or above, upon exposure to a gas mixture, a change in resistance of at least about 0.1 percent, and preferably at least about 1 percent, as compared to the resistance in the absence of exposure. Using such material, a signal may be generated that is proportional to the resistance of exhibited by the material when it is exposed to a multi-component gas mixture.

Regardless of the type of response characteristic that is measured for the purpose of analyzing a mixture and/or a gaseous component of interest therein, it is desirable that a sensor material be utilized for which a quantified value of that response characteristic is stable over an extended period of time. When the sensor material is exposed to a mixture containing the analyte, the concentration of the analyte being a function of the composition of the particular gas mixture in which it is contained, the value of the response of the sensor material will preferably remain constant or vary to only a small extent during exposure to the mixture over an extended period of time at a constant temperature. For example, the value of the response, if it varies, will vary by no more than about twenty percent, preferably no more than about ten percent, more preferably no more than about five percent, and most preferably no more than about one percent over a period of at least about 1 minute, or preferably a period of hours such as at least about 1 hour, preferably at least about 10 hours, more preferably at least about 100 hours, and most preferably at least about 1000 hours. One of the advantages of the types of sensor materials described above is that they are characterized by this kind of stability of response.

The electrical response characteristic exhibited by a chemo/electro-active material in respect of a multi-component gas mixture that contains an analyte gas or sub-group of gases derives from contact of the surface of the chemo/electro-active material with the gas mixture containing the analyte(s). The electrical response characteristic is an electrical property, such as capacitance, voltage, current, AC impedence, or AC or DC resistance, that is affected by exposure of the chemo/electro-active material to the multi-component gas mixture. A quantified value of, or a signal proportional to the quantified value of, the electrical property or a change in the electrical property may be obtained as a useful measurement at one or more times while the material is exposed to the gas mixture. The chemo/electro-active material may, however, be exposed to a gas mixture that, during extreme or even normal operating conditions, reduces its sensitivity, reduces the stability of the electrical response characteristic, or reduces the speed with which a change in the electrical response characteristic is detected.

The sensitivity of a chemo/electro-active material is related to the relative size, extent or quantity of the electrical response characteristic as measured upon exposure of the chemo/electro-active material to the gas mixture. Sensitivity is the ratio given by ΔR/ΔC where ΔR is the change in resistance, or in the size of a signal proportional to resistance, experienced by the chemo/electro-active material at a selected temperature as a result of a change in concentration of a component gas or subgroup of gases in the multi-component gas mixture, and ΔC is the change in concentration of the component gas or subgroup of gases. The individual gas or subgroup of gases of which there is a determination of change of concentration can be any of the gases or subgroups disclosed herein.

The stability of the electrical response characteristic of a chemo/electro-active material is the ratio given by ΔE/T where ΔE is the change in the quantified value of the electrical response characteristic, or in the size of a signal proportional to the electrical response characteristic, that occurs as a result of exposure to the multi-component gas mixture over a selected period of time, and T is the selected period of time.

A change in resistance may be measured in units of ohms; a change in concentration may be measured, for example, in ppm; a change as to an electrical response characteristic is measured in the units of that response characteristic; and a change in speed may be measured, for example, in cycles or units of time, or by a rate of heating or cooling in photometric means, or by photoelectric means.

A decrease in the stability of the electrical response characteristic of a chemo/electro-active material can be detected with an algorithm that models the expected response of the material to a multi-component gas mixture, and detects any deviation from that expected response. The algorithm can be written to predict whether the deviation also indicates a reduction in sensitivity and/or speed, and can thus indicate the need for taking steps to increase one, two or all three attributes of an electrical response characteristic. The problem of loss of stability often occurs, for example, after the chemo/electro-active material has been exposed to one or more nitrogen oxides in a multi-component gas mixture.

A decrease in sensitivity, stability or speed with respect to a chemo/electro-active material may be produced by absorption therein, but particularly by adsorption thereon, of large quantities of various gases, including the analyte(s). These gases only slowly desorb. Such a debilitated sensor may only slowly respond when exposed to low concentrations of the analyte gas(es). The effect of reduced sensitivity, stability and/or speed caused by high concentrations of various gases may be thought of as a “saturation” effect. The period of time required for a sensor to recover, after saturation from high concentration exposure, before it begins responding in a desirable manner to subsequently encountered low concentrations of analyte(s) is referred to as “blind time”.

An example of sensor debilitation is the event that occurs when a chemo/electro-active material is used for the measurement of nitrogen oxides in vehicle exhaust gases, and the sensor is exposed to high nitrogen oxide levels during regeneration of a NOx storage catalyst. Not only is the response of the chemo/electro-active material to NOx reduced during this exposure, but the chemo/electro-active material only slowly recovers when NOx concentration levels are eventually reduced. When a chemo/electro-active material is debilitated in a manner such as this, it should be restored to maximum performance. An important aspect of this invention is consequently a method of increasing the sensitivity, stability and/or speed of a chemo/electro-active material, which method is useful in a case of debilitation such as described.

The sensitivity, stability and/or speed of a chemo/electro-active material may be increased by raising its temperature. At an increased temperature, the tendency for gases such as analyte(s) to remain in and on the pores of the chemo/electro-active material is reduced. The temperature of a chemo/electro-active material may be raised with a heater that is incorporated into a substrate on which the chemo/electro-active material is mounted. A temperature increase may, if desired, occur at regular intervals while the chemo/electro-active material is in use, such as by raising the temperature following the passage of a pre-selected period, as may be measured in cycles or time.

In the example again of a NOx storage catalyst, the temperature of a sensor material could be increased either during a period of high gas concentration (e.g., during a period of catalyst regeneration when the sensor is in a reducing environment), or the temperature could be increased when the gas concentration returns to a low level (e.g., when the gas mixture again provides an oxidative environment). Information about the state of the engine at a particular point in time, e.g. whether it is producing oxidative or reducing exhaust, can be provided to a sensor control system from an engine control unit. The minimum operating temperature of a sensor material can also be made a function of predicted or historical gas concentrations.

Alternatively, the temperature of a sensor could be varied as a function of the average concentration of an individual analyte component, or subgroup of gases as an analyte, in the mixture. In the example again of a NOx storage catalyst, information from the sensor about gas concentration can be used to control the gas mixture during catalyst regeneration. The concentration of carbon monoxide produced by the engine and used for catalyst regeneration could, for example, be controlled in an arbitrary profile to optimize the regeneration process and minimize the deleterious effects on the sensor of NOx saturation.

In a further alternative, the sensor excitation voltage used for measuring sensor resistances can be changed as a function of measured gas concentrations.

When increasing the sensitivity of a chemo/electro-active material, the chemo/electro-active material may have a first sensitivity at a first temperature. The temperature of the chemo/electro-active material may be raised to a second temperature at which the sensitivity thereof is increased to a second sensitivity that is greater than the first sensitivity. The temperature may, if desired, be raised after the passage of a pre-selected period.

It is also possible, if desired, to determine whether or not the first sensitivity is equal to a pre-selected quantified value, or to determine whether or not the concentration in the multi-component gas mixture of an analyte component therein is equal to a pre-selected value. The analyte component may be any of the individual gases or subgroups of gases that have been named herein. Either of these determinations may be made after the passage of a pre-selected period.

The absolute value of the difference between the first sensitivity and the pre-selected quantified value may be not more than 80 percent, not more than 40 percent, not more than 20 percent, not more than 10 percent, or not more than 5 percent of the pre-selected value, as desired. The second sensitivity may be greater than the pre-selected value by more than 5 percent, more than 10 percent, more than 20 percent, more than 40 percent, or more than 80 percent, as desired. The second sensitivity may be greater than the first sensitivity by more than 25 percent, more than 50 percent, more than 100 percent, or more than 200 percent, as desired. If desired, it is also possible to include a step of calculating the first sensitivity.

When increasing the stability of an electrical response characteristic of a chemo/electro-active material, the chemo/electro-active material may have a first stability at a first temperature. The temperature of the chemo/electro-active material may be raised to a second temperature at which the stability thereof is increased to a second stability that is greater than the first stability. The temperature may, if desired, be raised after the passage of a pre-selected period.

It is also possible, if desired, to determine whether or not the first stability is equal to a pre-selected quantified value, or to determine whether or not the concentration in the multi-component gas mixture of an analyte component therein is equal to a pre-selected value. The analyte component may be any of the individual gases or subgroups of gases that have been named herein. Either of these determinations may be made after the passage of a pre-selected period.

The absolute value of the difference between the first stability and the pre-selected quantified value may be not more than 80 percent, not more than 40 percent, not more than 20 percent, not more than 10 percent, or not more than 5 percent of the pre-selected value, as desired. The second stability may be greater than the pre-selected value by more than 5 percent, more than 10 percent, more than 20 percent, more than 40 percent, or more than 80 percent, as desired. The second stability may be greater than the first stability by more than 25 percent, more than 50 percent, more than 100 percent, or more than 200 percent, as desired. If desired, it is also possible to include a step of calculating the first stability.

When increasing the speed with which a change in an electrical response characteristic of a chemo/electro-active material is detected, detection of change in the electrical response characteristic may be occurring at a first speed at a first temperature. The temperature of the chemo/electro-active material may be raised to a second temperature at which the speed with which the electrical response characteristic of the chemo/electro-active material is detected is increased to a second speed that is greater than the first speed. The temperature may, if desired, be raised after the passage of a pre-selected period.

It is also possible, if desired, to determine whether or not the first speed is equal to a pre-selected quantified value, or to determine whether or not the concentration in the multi-component gas mixture of an analyte component therein is equal to a pre-selected value. The analyte component may be any of the individual gases or subgroups of gases that have been named herein. Either of these determinations may be made after the passage of a pre-selected period.

The absolute value of the difference between the first speed and the pre-selected quantified value may be not more than 80 percent, not more than 40 percent, not more than 20 percent, not more than 10 percent, or not more than 5 percent of the pre-selected value, as desired. The second speed may be greater than the pre-selected value by more than 5 percent, more than 10 percent, more than 20 percent, more than 40 percent, or more than 80 percent, as desired. The second speed may be greater than the first speed by more than 25 percent, more than 50 percent, more than 100 percent, or more than 200 percent, as desired. If desired, it is also possible to include a step of calculating the first speed.

In the methods described herein, the temperature of the chemo/electro-active material may be raised by more than 25° C., more than 50° C., more than 100° C., or more than 200° C., as desired. The first temperature may be at least 400° C., at least 500° C., at least 600° C., at least 700° C., at least 800° C., or at least 900° C., as desired. The temperature of the chemo/electro-active material may be raised to a second temperature of 500° C. or more, 600° C. or more, 700° C. or more, 800° C. or more, 900° C. or more, or 1000° C. or more, as desired. A pre-selected period may be measured in cycles or time.

When increasing the sensitivity of a chemo/electro-active material, the chemo/electro-active material may have a first sensitivity at a first concentration of a gaseous component, such as an analyte. The concentration of the gaseous component may be decreased to a second concentration at which the sensitivity of the chemo/electro-active material is increased to a second sensitivity that is greater than the first sensitivity. The concentration of the gaseous component may, if desired, be reduced after the passage of a pre-selected period, measured in cycles, or time.

It is also possible, if desired, to determine whether or not the first sensitivity is equal to a pre-selected quantified value, or to determine whether or not the concentration in the multi-component gas mixture of the gaseous component therein is equal to a pre-selected value. The gaseous component may be any of the individual gases or subgroups of gases that have been named herein. The concentration of the gaseous component may be decreased by contact with another gas or gases, which may also be any of the individual gases or subgroups of gases that have been named herein. For example, the concentration of NOx may be reduced by contacting the NOx with carbon monoxide. The concentration of the gaseous component may be decreased by at least 5%, at least 10%, at least 20%, at least 40%, or at least 80%, as desired. The concentration of the gaseous component may also be decreased to increase the stability of the electrical response characteristic of the chemo/electro-active material, or to increase the speed with which a change in the electrical response characteristic is detected.

The absolute value of the difference between the first sensitivity and the pre-selected quantified value may be not more than 80 percent, not more than 40 percent, not more than 20 percent, not more than 10 percent, or not more than 5 percent of the pre-selected value, as desired. The second sensitivity may be greater than the pre-selected value by more than 5 percent, more than 10 percent, more than 20 percent, more than 40 percent, or more than 80 percent, as desired. The second sensitivity may be greater than the first sensitivity by more than 25 percent, more than 50 percent, more than 100 percent, or more than 200 percent, as desired. If desired, it is also possible to include a step of calculating the first sensitivity.

Other alternative embodiments of this invention, in a chemo/electro-active material that exhibits an electrical response characteristic to a multi-component gas mixture, may include the following:

a method of increasing the sensitivity of the chemo/electro-active material that is at a first temperature, by determining or measuring the sensitivity of the chemo/electro-active material, and raising the temperature of the chemo/electro-active material to a second temperature at which the sensitivity of the chemo/electro-active material is increased;

a method of increasing the sensitivity of the chemo/electro-active material that is at a first temperature, by determining or measuring a reduction in the sensitivity of the chemo/electro-active material from a first amount to a second amount, and raising the temperature of the chemo/electro-active material to a second temperature at which the sensitivity of the chemo/electro-active material is increased above the second amount.

a method of increasing the sensitivity of the chemo/electro-active material, by exposing the chemo/electro-active material to the gas mixture, which has a first temperature, following the passage of a pre-selected period after exposure, determining or measuring the sensitivity of the chemo/electro-active material, and raising the temperature of the chemo/electro-active material to a second temperature at which the sensitivity of the chemo/electro-active material is increased.

a method of increasing the sensitivity of the chemo/electro-active material that is at a first temperature, by determining an increase in the concentration of an analyte component, determining the sensitivity of the chemo/electro-active material, and raising the temperature of the chemo/electro-active material to a second temperature at which the sensitivity of the chemo/electro-active material is increased.

a method of increasing the sensitivity of the chemo/electro-active material, comprising determining or measuring a reduction in the sensitivity of the chemo/electro-active material from a first amount to a second amount, and decreasing the concentration of an analyte component in the mixture to a concentration at which the sensitivity of the chemo/electro-active material is increased above the second amount.

An electrical response is determined for each chemo/electro-active material upon exposure of the array to a gas mixture, and means for determining the response include conductors interconnecting the sensor materials. The conductors are in turn connected to electrical input and output circuitry, including data acquisition and manipulation devices as appropriate to measure and record a response exhibited by a sensor material in the form of an electrical signal. The value of a response, such as a measurement related to resistance, may be indicated by the size of the signal. One or more signals may be generated by an array of sensors as to each analyte component in the mixture, whether the analyte is one or more individual gases and/or one or more subgroups of gases.

An electrical response is determined for each individual chemo/electro-active material separately from that of each of the other chemo/electro-active materials. This can be accomplished by accessing each chemo/electro-active material with an electric current sequentially, using a multiplexer to provide signals differentiated between one material and another in, for example, the time domain or frequency domain. It is consequently preferred that no chemo/electro-active material be joined in a series circuit with any other such material. One electrode, by which a current is passed to a chemo/electro-active material, can nevertheless be laid out to have contact with more than one material. An electrode may have contact with all, or fewer than all, of the chemo/electro-active materials in an array. For example, if an array has 12 chemo/electro-active materials, an electrode may have contact with each member of a group of 2, 3, 4, 5 or 6 (or, optionally, more in each instance) of the chemo/electro-active materials. The electrode will preferably be laid out to permit an electrical current to be passed to each member of such group of chemo/electro-active materials sequentially.

A conductor such as a printed circuit may be used to connect a voltage source to a sensor material, and, when a voltage is applied across the sensor material, a corresponding current is created through the material. Although the voltage may be AC or DC, the magnitude of the voltage will typically be held constant. The resulting current is proportional to both the applied voltage and the resistance of the sensor material. A response of the material in the form of either the current, voltage or resistance may be determined, and means for doing so include commercial analog circuit components such as precision resistors, filtering capacitors and operational amplifiers (such as a OPA4340). As voltage, current and resistance is each a known function of the other two electrical properties, a known quantity for one property may be readily converted to that of another.

Resistance may be determined, for example, in connection with the digitization of an electrical response. Means for digitizing an electrical response include an analog to digital (A/D) converter, as known in the art, and may include, for example, electrical components and circuitry that involve the operation of a comparator. An electrical response in the form of a voltage signal, derived as described above as a result of applying a voltage across a sensor material, is used as an input to a comparator section (such as a LM339). The other input to the comparator is driven by a linear ramp produced by charging a capacitor using a constant current source configured from an operational amplifier (such as a LT1014) and an external transistor (such as a PN2007a). The ramp is controlled and monitored by a microcomputer (such as a T89C51CC01). A second comparator section is also driven by the ramp voltage, but is compared to a precise reference voltage. The microcomputer captures the length of time from the start of the ramp to the activation of the comparators to generate a signal based on the counted time.

The resistance of the sensor material is then calculated, or quantified as a value, by the microcomputer from the ratio of the time signal derived from the voltage output of the material to a time signal corresponding to a known look-up voltage and, ultimately, to the resistance that is a function of the look-up voltage. A microprocessor chip, such as a T89C51CC01, can be used for this function. The microprocessor chip may also serve as means for determining a change in the resistance of a sensor material by comparing a resistance, determined as above, to a previously determined value of the resistance.

Electrical properties such as impedance or capacitance may be determined, for example, by the use of circuitry components such as an impedance meter, a capacitance meter or inductance meter.

Means for digitizing the temperature of an array of chemo/electro-active materials can include, for example, components as described above that convert a signal representative of a physical property, state or condition of a temperature measuring device to a signal based on counted time.

In one embodiment, analysis of a multi-component gas mixture is complete upon the generation of an electrical response, such as resistance, in the manner described above. As a measurement of resistance exhibited by a sensor material upon exposure to a gas mixture is a function of the partial pressure within the mixture of one or more component gases, the measured resistance provides useful information about the composition of the gas mixture. The information may, for example, indicate the presence or absence within the mixture of a particular gas or subgroup of gases. In other embodiments, however, it may be preferred to manipulate, or further manipulate, an electrical response in the manner necessary to obtain information related to the concentration within the mixture of one or more particular component gases or subgroups of gases, or to calculate the actual concentration within the mixture of one or more component gases or subgroups.

Means for obtaining information concerning the relative concentration within the mixture of one or more individual component gases and/or one or more subgroups of gases, or for detecting the presence of, or calculating the actual concentration of, one or more individual component gases and/or subgroups within the mixture, may include a modeling algorithm that incorporates either a PLS (Projection onto Latent Systems) model, a back-propagation neural network model, or a combination of the two, along with signal pre-processing and output post-processing. Signal pre-processing includes, but is not limited to, such operations as principle component analyses, simple linear transformations and scaling, logarithmic and natural logarithmic transformations, differences of raw signal values (e.g., resistances), and differences of logarithmic values. The algorithm contains a model whose parameters have been previously determined, and that empirically models the relationship between the pre-processed input signal and information related to the gas concentration of the species of interest. Output post-processing includes, but is not limited to, all of the operations listed above, as well as their inverse operations.

The model is constructed using equations in which constants, coefficients or other factors are derived from pre-determined values characteristic of a precisely measured electrical response of an individual sensor material to a particular individual gas or subgroup expected to be present as a component in the mixture to be analyzed. The equations may be constructed in any manner that takes temperature into account as a value separate and apart from the electrical responses exhibited by the sensor materials upon exposure to a gas mixture. Each individual sensor material in the array differs from each of the other sensors in its response to at least one of the component gases or subgroups in the mixture, and these different responses of each of the sensors is determined and used to construct the equations used in the model.

A change of temperature in the array may be indicated by a change in the quantified value of an electrical response characteristic, resistance for example, of a sensor material. At a constant partial pressure in the mixture of a gas of interest, the value of an electrical response characteristic of a sensor material may vary with a change in temperature of the array, and thus the material. This change in the value of an electrical response characteristic may be measured for the purpose of determining or measuring the extent of change of, and thus a value for, temperature. The temperature of the array will be the same, or substantially the same, as the temperature of the gas mixture unless the array is being maintained at a pre-selected temperature by a heater located on the substrate. If the array is being heated by a heater, the temperature of the array will lie substantially in the range within which the heater cycles on and off.

It is not required, but is preferred, that the measurement of temperature be made independently of information related to the compositional content of a gas mixture. This can be done by not using sensors that provide compositional information for the additional purpose of determining temperature, and, optionally, by connecting the temperature measuring device in parallel circuitry with the sensor materials, rather than in series. Means for measuring temperature include a thermocouple or a pyrometer incorporated with an array of sensors. If the termperature determining device is a thermistor, which is typically a material that is not responsive to an analyte gas, the thermistor is preferably made from a different material than the material from which any of the gas sensors is made. Regardless of the method by which temperature or change in temperature is determined, a temperature value or a quantified change in temperature is a desirable input, preferably in digitized form, from which an analysis of a mixture of gases and/or a component therein may be performed.

In the method and apparatus of this invention, unlike various prior-art technologies, there is no need to separate the component gases of a mixture for purposes of performing an analysis, such as by a membrane or electrolytic cell. There is also no need when performing an analysis by means of this invention to employ a reference gas external to the system, such as for the purpose of bringing a response or analytical results back to a base line value. A value representative of a reference state may, however, be used as a factor in an algorithm by which information related to the composition of the gas mixture is determined. With the exception of preliminary testing, during which a standardized response value to be assigned to the exposure of each individual sensor material to each individual analyte gas is determined, the sensor materials are exposed only to the mixture in which an analyte gas and/or subgroup is contained. The sensor materials are not exposed to any other gas to obtain response values for comparison to those obtained from exposure to the mixture containing an analyte. The analysis of the mixture is therefore performed only from the electrical responses obtained upon exposure of the chemo/electro-active materials to the mixture containing the analyte. No information about an analyte gas and/or subgroup is inferred by exposure of the sensor materials to any gas other than the analyte itself as contained within the mixture.

This invention is therefore useful at the higher temperatures found in automotive emission systems, typically in the range of from about 400° C. to about 1000° C. In addition to gasoline and diesel internal combustion engines, however, there is a variety of other combustion processes to which this invention could be applied, including stack or burner emissions of all kinds such as resulting from chemical manufacturing, electrical generation, waste incineration and air heating. These applications require the detection of gases such as nitrogen oxides, ammonia, carbon monoxide, hydrocarbons and oxygen at the ppm to percent levels, typically in a highly corrosive environment.

When the multi-component gas mixture comprises a nitrogen oxide, a hydrocarbon, or both, or any of the other gases mentioned herein, the apparatus may be used to determine the presence and/or concentration of a nitrogen oxide and/or hydrocarbon in the multi-component gas mixture. The apparatus may also be used to determine the presence and/or concentration of any one or more to the other gases mentioned herein that may be present in a multi-component gas mixture. For this purpose, the electrical response, in the apparatus of this invention, of one or more of a chemo/electro-active material that comprises M¹Oₓ, a chemo/electro-active material that comprises M¹ₐM²_{b}Oₓ, and a chemo/electro-active material that comprises M¹ₐM²_{b}M³_{c}Oₓ, may be related to one or more of the presence of a nitrogen oxide within the gas mixture, the presence of a hydrocarbon within the gas mixture, the collective concentration of all nitrogen oxides within the gas mixture, and the concentration of a hydrocarbon within the gas mixture.

This invention is also useful for detecting and measuring gases in other systems such as those in which odor detection is important, and/or that are at lower temperature, such as in the medical, agricultural or food and beverage industries, or in the ventilation system of a building or a vehicle for transportation. An array of chemo/electro-active materials could be used, for example, to supplement the results of, or calibrate, a gas chromatograph.

This invention therefore provides methods and apparatus for directly sensing the presence and/or concentration of one or more gases in an multi-component gas system, comprising an array of at least two chemo/electro-active materials chosen to detect analyte gases or subgroups of gases in a multi-component gas stream. The multi-component gas system can be at essentially any temperature that is not so low or so high that the sensor materials are degraded or the sensor apparatus otherwise malfunctions. In one embodiment, the gas system may be at a lower temperature such as room temperature (about 25° C.) or elsewhere in the range of about 0° C. to less than about 100° C., whereas in other embodiments the gas mixture may at a higher temperature such as in the range of about 400° C. to about 1000° C. or more. The gas mixture may therefore have a temperature that is about 0° C. or more, about 100° C. or more, about 200° C. or more, about 300° C. or more, about 400° C. or more, about 500° C. or more, about 600° C. or more, about 700° C. or more, or about 800° C. or more, and yet is less than about 1000° C., is less than about 900° C., is less than about 800° C., is less than about 700° C., is less than about 600° C., is less than about 500° C., is less than about 400° C., is less than about 300° C., is less than about 200° C., or is less than about 100° C.

In applications in which the gas mixture is above about 400° C., the temperature of the sensor materials and the array may be determined substantially only, and preferably is determined solely, by the temperature of the gas mixture in which a gaseous analyst is contained. This is typically a variable temperature. When higher-temperature gases are being analyzed, it may be desirable to provide a heater with the array to bring the sensor materials quickly to a minimum temperature. Once the analysis has begun, however, the heater (if used) is typically switched off, and no method is provided to maintain the sensor materials at a preselected temperature. The temperature of the sensor materials thus rises or falls to the same extent that the temperature of the surrounding environment does. The temperature of the surrounding environment, and thus the sensors and the array, is typically determined by (or results from) substantially only the temperature of the gas mixture to which the array is exposed.

In applications in which the gas mixture is below about 400° C., it may be preferred to maintain the sensor materials and the array at a preselected temperature of about 200° C. or above, and preferably 400° C. or above. This preselected temperature may be substantially constant, or preferably is constant. The preselected temperature may also be about 500° C. or above, about 600° C. or above, about 700° C. or above, about 800° C. or above, about 900° C. or above, or about 1000° C. or above. This may be conveniently done with a heater incorporated with the array, in a manner as known in the art. If desired, a separate micro heater means may be supplied for each separate chemo/electro-active material, and any one or more of the materials may be heated to the same or a different temperature. The temperature of the gas mixture in such case may also be below about 300° C., below about 200° C., below about 100° C., or below about 50° C. In these low temperature application, the means for heating the chemo/electro-active materials may be a voltage source that has a voltage in the range of about 10⁻³ to about 10⁻⁶ volts. The substrate on which the materials are placed may be made of a materials that is selected from one or more of the group consisting of silicon, silicon carbide, silicon nitride, and alumina containing a resistive dopant. Devices used in these low temperature applications are often small enough to be held in the human hand.

This heating technique is also applicable, however, to the analysis of high temperature gases. When the temperature of the gas mixture is above about 400° C., the sensor materials may nevertheless be maintained by a heater at a constant or substantially constant preselected temperature that is higher than the temperature of the gas mixture. Such preselected temperature may be about 500° C. or above, about 600° C. or above, about 700° C. or above, about 800° C. or above, about 900° C. or above, or about 1000° C. or above. Should the temperature of the gas mixture exceed the temperature pre-selected for the heater, the heater may be switched off during such time. A temperature sensor will still be employed, however, to measure the temperature of the gas mixture and provide that value as an input to an algorithm by which information related to the composition of the gas mixture is determined.

The gas mixture to be analyzed may be emitted by a process, or may be a product of a chemical reaction that is transmitted to a device. In such instance, the apparatus of this inveniton may further include means for utilizing the electrical response of an array, and optionally a temperature measurement, for the purpose of controlling the process or the device.

Means for utilizing an electrical response of a sensor material, and optionally a temperature measurement, for controlling a process or device include a decision making routine to control, for example, the chemical reaction of combustion that occurs in an internal combustion engine, or to control the engine itself, or components or equipment associated therewith.

Combustion is a process in which the chemical reaction of the oxidation of a hydrocarbon fuel occurs in the cylinder of an engine. An engine is a device to which a result of that chemical reaction is transmitted, the result being the force generated by the combustion reaction to the work necessary to move the piston in the cylinder. Another example of a process that emits a multi-component mixture of gases is the chemical reaction that occurs in a fuel cell, and other examples of a device to which a product of a chemical reaction is transmitted is a boiler, such as used in a furnace or for power generation, or a scrubber in a stack to which waste gases are transmitted for pollution abatement treatment.

In the case of an engine, to control the process of combustion or the operation of the engine itself, a microcomputer (such as a T89C51CC01) performs a multitude of decision-making routines about various parameters of the process of combustion or about operating characteristics of the engine. The microcomputer gathers information about the compositional content of the engine exhaust, and does so by obtaining the responses of an array of chemo/electro-active materials that have been exposed to the stream of exhaust, and optionally obtains a temperature measurement. The information is temporarily stored in a random access memory, and the microcomputer then applies one or more decision-making routines to the information.

A decision-making routine utilizes one or more algorithms and/or mathematical operations to manipulate the acquired information to generate a decision in the form of a value that is equivalent to a desired state or condition that should be possessed by a particular parameter of the process, or by an operating characteristic of the device. Based on the result of a decision-making routine, instructions are given by or are controlled by the microcomputer that cause an adjustment in the state or condition of a parameter of the process or an operating characteristic of the device. In the case of the process embodied by the chemical reaction of combustion, the process can be controlled by adjusting a parameter of the reaction, such as the relative amount of the reactants fed thereto. The flow of fuel or air to the cylinder, for example, can be increased or decreased. In the case of the engine itself, being a device to which a result of the reaction of combustion is transmitted, control can be accomplished by adjusting an operating characteristic of the engine such as torque or engine speed.

An internal combustion engine and the associated components and equipment, controlled by the methods and apparatus of this invention, can be used for many different purposes including, for example, in any type of vehicle for transportation or recreation such as a car, truck, bus, locomotive, aircraft, spacecraft, boat, jet ski, all-terrain vehicle or snowmobile; or in equipment for construction, maintenance or industrial operations such as pumps, lifts, hoists, cranes, generators, or equipment for demolition, earth moving, digging, drilling, mining or groundskeeping.

In summary, it may be seen that this invention provides means to determine, measure and record responses exhibited by each of the chemo/electro-active materials present in an array upon exposure to a gas mixture. Any means that will determine, measure and record changes in electrical properties can be used, such as a device that is capable of measuring the change in AC impedance of the materials in response to the concentration of adsorbed gas molecules at their surfaces. Other means for determining electrical properties are suitable devices to measure, for example, capacitance, voltage, current or DC resistance. Alternatively a change in temperature of the sensing material may be measured and recorded. The chemical sensing method and apparatus may further provide means to measure or analyze a mixture and/or the detected gases such that the presence of the gases are identified and/or their concentrations are measured. These means can include instrumentation or equipment that is capable, for example, of performing chemometrics, neural networks or other pattern recognition techniques. The chemical sensor apparatus will further comprise a housing for the array of chemo/electro-active materials, the means for detecting, and means for analyzing.

The device includes a substrate, an array of at least two chemo/electro-active materials chosen to detect one or more predetermined gases in a multi-component gas stream, and a means to detect changes in electrical properties in each of the chemo/electro-active materials present upon exposure to the gas system. The array of sensor materials should be able to detect an analyte of interest despite competing reactions caused by the presence of the several other components of a multi-component mixture. For this purpose, this invention uses an array or multiplicity of sensor materials, as described herein, each of which has a different sensitivity for at least one of the gas components of the mixture to be detected. A sensor that has the needed sensitivity, and that can operate to generate the types of analytical measurements and results described above, is obtained by selection of appropriate compositions of materials from which the sensor is made. Various suitable types of materials for this purpose are described above. The number of sensors in the array is typically greater than or equal to the number of individual gas components to be analyzed in the mixture.

Further description relevant to the apparatus of this invention, uses for the apparatus and methods of using the apparatus may be found in U.S. Provisional Application No. 60/370,445, filed Apr. 5, 2002, and U.S. application Ser. No. 10/117,472, filed Apr. 5, 2002, each of which is incorporated in its entirety as a part hereof for all purposes.

What is claimed is:

1. In a chemo/electro-active material that exhibits an electrical response characteristic to a multi-component gas mixture, a method of increasing the sensitivity of the chemo/electro-active material that has a first sensitivity at a first temperature, comprising
raising the temperature of the chemo/electro-active material to a second temperature at which the sensitivity of the chemo/electro-active material is increased to a second sensitivity that is greater than the first sensitivity;
wherein the sensitivity of the chemo/electro-active material is the ratio given by ΔR/ΔC where
ΔR is the change in resistance, or in the size of a signal proportional to resistance, experienced by the chemo/electro-active material at a selected temperature as a result of a change in concentration of a component gas or subgroup of gases in the multi-component gas mixture, and
ΔC is the change in concentration of the component gas or subgroup of gases.

2. A method according to claim 1 wherein the temperature of the chemo/electro-active material is raised after the passage of a preselected period.

3. A method according to claim 1 further comprising a step of determining that the first sensitivity is not equal to a pre-selected quantified value.

4. A method according to claim 1 further comprising a step of determining that the concentration in the multi-component gas mixture of an analyte component therein is not equal to a pre-selected value.

5. A method according to claim 4 wherein the analyte component is one or more nitrogen oxides.

6. A method according to claim 1 wherein the electrical response characteristic is resistance.

7. A method according to claim 1 wherein the first temperature is at least 400C.

8. A method according to claim 1 wherein the temperature of the chemo/electro-active material is raised by more than 25° C.

9. A method according to claim 1 wherein the temperature of the chemo/electro-active material is raised to a second temperature of 500° C. or more.

10. A method according to claim 1 wherein the component gas is a hydrocarbon.

11. A method according to claim 1 wherein the component gas is a nitrogen oxide.

12. A method according to claim 1 wherein the subgroup of gases are nitrogen oxides.

13. In a chemo/electro-active material that exhibits an electrical response characteristic to a multi-component gas mixture, a method of increasing the stability of the electrical response characteristic of the chemo/electro-active material that has a first stability at a first temperature, comprising
raising the temperature of the chemo/electro-active material to a second temperature at which the stability of the chemo/electro-active material is increased to a second stability that is greater than the first stability;
wherein the stability of the electrical response characteristic of the chemo/electro-active material is the ratio given by ΔE/T where
ΔE is the change in the quantified value of the electrical response characteristic, or in the size of a signal proportional to the electrical response characteristic, that occurs as a result of exposure to the multi-component gas mixture over a selected period of time, and
T is the selected period of time.

14. A method according to claim 13 wherein the temperature of the chemo/electro-active material is raised after the passage of a preselected period.

15. A method according to claim 13 further comprising a step of determining that the first stability is not equal to a pre-selected quantified value.

16. A method according to claim 13 further comprising a step of determining that the concentration in the multi-component gas mixture of an analyte component therein is not equal to a pre-selected value.

17. A method according to claim 16 wherein the analyte component is one or more nitrogen oxides.

18. A method according to claim 13 wherein the electrical response characteristic is resistance.

19. A method according to claim 13 wherein the first temperature is at least 400C.

20. A method according to claim 13 wherein the temperature of the chemo/electro-active material is raised by more than 25° C.

21. A method according to claim 13 wherein the temperature of the chemo/electro-active material is raised to a second temperature of 500° C. or more.

22. A method according to claim 13 wherein the gas mixture contains one or more hydrocarbons.

23. A method according to claim 13 wherein the gas mixture contains one or more nitrogen oxides.

24. In a chemo/electro-active material that exhibits an electrical response characteristic to a multi-component gas mixture, a method of increasing the speed with which a change in an electrical response characteristic is detected where the change in the electrical response characteristic is detected at a first speed at a first temperature, comprising
raising the temperature of the chemo/electro-active material to a second temperature at which the speed with which the electrical response characteristic of the chemo/electro-active material is detected is increased to a second speed that is greater than the first speed.

25. A method according to claim 24 wherein the temperature of the chemo/electro-active material is raised after the passage of a preselected period.

26. A method according to claim 24 further comprising a step of determining that the first speed is not equal to a pre-selected quantified value.

27. A method according to claim 24 further comprising a step of determining an that the concentration in the multi-component gas mixture of an analyte component therein is not equal to a pre-selected value.

28. A method according to claim 27 wherein the analyte component is one or more nitrogen oxides.

29. A method according to claim 24 wherein the electrical response characteristic is resistance.

30. A method according to claim 24 wherein the first temperature is at least 400C.

31. A method according to claim 24 wherein the temperature of the chemo/electro-active material is raised by more than 25° C.

32. A method according to claim 24 wherein the temperature of the chemo/electro-active material is raised to a second temperature of 500° C. or more.

33. A method according to claim 24 wherein the gas mixture contains one or more hydrocarbons.

34. A method according to claim 24 wherein the gas mixture contains one or more nitrogen oxides.

35. In a chemo/electro-active material that exhibits an electrical response characteristic to a multi-component gas mixture containing a gaseous component, a method of increasing the sensitivity of the chemo/electro-active material that has a first sensitivity at a first concentration of the gaseous component, comprising
reducing the concentration of the gaseous component to a second concentration at which the sensitivity of the chemo/electro-active material is increased to a second sensitivity that is greater than the first sensitivity;
wherein the sensitivity of the chemo/electro-active material is the ratio given by ΔR/ΔC where
ΔR is the change in resistance, or in the size of a signal proportional to resistance, experienced by the chemo/electro-active material at a selected temperature as a result of a change in concentration of a component gas or subgroup of gases in the multi-component gas mixture, and
ΔC is the change in concentration of the component gas or subgroup of gases.

36. A method according to claim 35 wherein the concentration of the gaseous component is reduced after the passage of a pre-selected period.

37. A method according to claim 35 further comprising a step of determining that the first sensitivity is not equal to a pre-selected quantified value.

38. A method according to claim 35 further comprising a step of determining that the concentration of the gaseous component in the multi-component gas mixture is not equal to a pre-selected value.

39. A method according to claim 35 wherein the gaseous component is one or more nitrogen oxides.

40. A method according to claim 35 wherein the electrical response characteristic is resistance.

41. A method according to claim 35 wherein the concentration of the gaseous component in the multi-component gas mixture is reduced by contact with another gas.
